(19) United States
(12) Patent Application Publication
(10) Pub. No.: US 2012/0183148 A1
(43) Pub. Date: Jul. 19, 2012

(54) SYSTEM FOR MULTICHANNEL MULTITRACK AUDIO AND AUDIO PROCESSING METHOD THEREOF

(75) Inventors: Choong Sang CHO, Seongnam-si (KR); Je Woo KIM, Seongnam-si (KR); Byeong Ho CHOI, Yongin-si (KR); Hwa Seon SHIN, Seongnam-si (KR)

(73) Assignee: KOREA ELECTRONICS TECHNOLOGY INSTITUTE, Seongnam-si (KR)

(21) Appl. No.: 13/340,353

(22) Filed: Dec. 29, 2011

(30) Foreign Application Priority Data
Jan. 14, 2011 (KR) 10-2011-0004198

(51) Int. Cl. H04R 5/00

(52) U.S. Cl. 381/22; 381/23

(57) ABSTRACT

A multichannel multitrack audio system and an audio processing method are provided. The audio processing method down-mixes and encodes a first audio object constituting the audio from multiple channels to a lower number of channels. Thus, the method for down-mixing audio objects of the audio from the multichannel to the lower number of channels generates the multichannel multi-object audio and reproduces the generated multichannel multi-object audio. Abrupt data increase can be addressed in processing the multichannel multi-object audio.

### CROSS-REFERENCE TO RELATED APPLICATION(S) AND CLAIM OF PRIORITY

The present application claims the benefit under 35 U.S.C. §119(a) to a Korean patent application filed in the Korean Intellectual Property Office on Jan. 14, 2011, and assigned Serial No. 10-2011-0004198, the entire disclosure of which is hereby incorporated by reference.

### TECHNICAL FIELD OF THE INVENTION

The present invention relates generally to an audio system and an audio processing method. More particularly, the present invention relates to an audio system for audio including multichannel audio objects, and an audio processing method thereof.

### BACKGROUND OF THE INVENTION

The existing realistic object audio independently compresses audio objects constituting the audio. Such a compression is free from problems when the audio objects are in mono or in stereo.

However, when the audio objects are in multichannel such as 5.1 channel, their data size is too big considering the data reduction through the compression. Thus, a great storage space is required and much load occurs in the audio data processing.

Meanwhile, a method using Spatial Audio Object Coding (SAOC) standardized by MPEG can be considered, but this method cannot completely restore the audio objects.

### SUMMARY OF THE INVENTION

To address the above-discussed deficiencies of the prior art, it is a primary aspect of the present invention to provide an audio processing method for generating a multichannel multi-object audio by down-mixing audio objects constituting the audio from multiple channels to a lower number of channels, and playing the generated multichannel multi-object audio.

Another aspect of the present invention is to provide an audio processing method for generating a multichannel multi-object audio by classifying and mixing part of audio objects constituting the audio based on a channel and then down-mixing from multiple channels to a lower number of channels, and playing the generated multichannel multi-object audio.

According to one aspect of the present invention, an audio processing method includes down-mixing a first audio object constituting audio from multichannel to a lower number of channels; and encoding the first audio object down-mixed.

The audio processing method may further include down-mixing a second audio object constituting the audio from multichannel to a lower number of channels; encoding the second audio object down-mixed; and generating single multichannel multitrack audio by multiplexing the first audio object down-mixed and encoded and the second audio object down-mixed and encoded.

The audio processing method may further include generating a third audio object by classifying and mixing part of the audio objects of the audio per channel; down-mixing the third audio objects from multichannel to a lower number of channels; encoding the third audio objects down-mixed; and generating single multichannel multitrack audio by multiplexing the first audio object down-mixed and encoded and the third audio object down-mixed and encoded.

The lower number of the channels may be one or two.

According to another aspect of the present invention, an audio processing method includes decoding a first audio object constituting audio, the audio object down-mixed and then encoded; and up-mixing the decoded first audio object down-mixed, from a lower number of channels to multichannel.

The audio processing method may further include decoding the second audio object constituting the audio, the audio object down-mixed and encoded; up-mixing the decoded second audio object down-mixed, from a lower number of channels to multichannel; and generating single multichannel audio by mixing the first audio object up-mixed and the second audio object up-mixed.

The audio processing method may further include classifying and mixing part of audio objects constituting the audio per channel, and decoding a third audio object down-mixed from multichannel to a lower number of channels; up-mixing the decoded third audio object down-mixed, from a lower number of channels to multichannel; and generating single multichannel audio by mixing the first audio object up-mixed and the third audio object up-mixed.

The audio processing method may further include classifying and mixing part of audio objects constituting the audio per channel, and decoding a third audio object down-mixed from multichannel to a lower number of channels; and generating single audio of a lower number of channels by mixing the first audio object decoded and up-mixed and the third audio object decoded and up-mixed.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram of a multichannel multitrack audio generating apparatus according to an exemplary embodiment of the present invention;

FIG. 2 is a flowchart of a method for generating the multichannel multitrack audio according to an exemplary embodiment of the present invention;

FIG. 3 is a block diagram of a multichannel multitrack audio reproducing apparatus according to an exemplary embodiment of the present invention; and

FIG. 4 is a flowchart of a method for reproducing the multichannel multitrack audio according to an exemplary embodiment of the present invention.

Throughout the drawings, like reference numerals will be understood to refer to like parts, components and structures.

### DETAILED DESCRIPTION OF THE INVENTION

The following description with reference to the accompanying drawings is provided to assist in a comprehensive understanding of exemplary embodiments of the invention as defined by the claims and their equivalents.

1. Multichannel Multitrack Audio Generating Apparatus

A multichannel multitrack audio includes a plurality of audio objects, and the audio objects indicate the multichannel audio. For example, when the audio includes

1) an audio object “Vocal” of 5.1 channel,

2) an audio object “Drum” of 5.1 channel,

3) an audio object “Bass” of 5.1 channel,

4) an audio object “Guitar” of 5.1 channel, and

5) an audio object “Violin” of 5.1 channel, the audio is the multichannel multitrack audio.

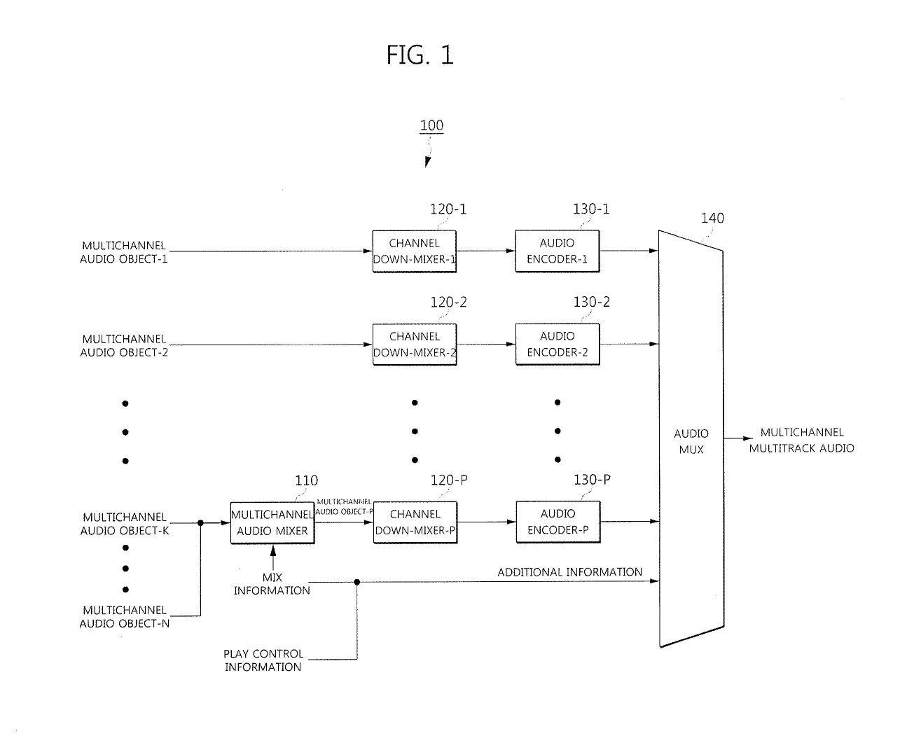

FIG. 1 is a block diagram of a multichannel multitrack audio generating apparatus according to an exemplary embodiment of the present invention. The multichannel multitrack audio generating apparatus 100 classifies the multichannel audio objects constituting the audio based on the object, and down-mixes the audio objects to a lower number of channels.

The multichannel multitrack audio generating apparatus 100 can classify some multichannel audio objects based on the channel, mix them to one audio object, and then down-mix the one audio object to a lower number of channels.

Such a multichannel multitrack audio generating apparatus 100 includes a multichannel audio mixer 110, channel down-mixers 120-1 through 120-P, audio encoders 130-1 through 130-P, and an audio MUX 140 as shown in FIG. 1.

The multichannel audio mixer 110 classifies and mixes multichannel audio objects K through N per channel. Accordingly, the multichannel audio mixer 110 generates and outputs the single multichannel audio object P.

The multichannel audio mixer 110 mixes (N-K−1)-ary multichannel audio objects, and N-K−1 is an integer greater than 2 and determined by specifications of the multichannel multitrack audio generating apparatus 100. N-K−1 is not necessarily fixed and can vary according to the multichannel multitrack audio to generate.

The classification and the mixing per channel imply that the multichannel audio objects input to the multichannel audio mixer 110 are mixed based on the same channel. For example, the classification and the mixing of the audio object “Bass” of 5.1 channel, the audio object “Guitar” of 5.1 channel, and the audio object “Violin” of 5.1 channel per channel imply that,

1) a L-channel of Bass, a L-channel of Guitar, and a L-channel of Violin are mixed,

2) a R-channel of Bass, a R-channel of Guitar, and a R-channel of Violin are mixed,

3) a RL-channel of Bass, a RL-channel of Guitar, and a RL-channel of Violin are mixed,

4) a RR-channel of Bass, a RR-channel of Guitar, and a RR-channel of Violin are mixed,

5) a C-channel of Bass, a C-channel of Guitar, and a C-channel of Violin are mixed, and

6) a SW-channel of Bass, a SW-channel of Guitar, and a SW-channel of Violin are mixed.

Accordingly, when the multichannel audio objects input to the multichannel audio mixer 110 are in 5.1 channel, the multichannel audio object P output from the multichannel audio mixer 110 is in 5.1 channel as well.

Meanwhile, the multichannel audio mixer 110 mixes the multichannel audio objects according to input mix information. Herein, the mix information includes information of the multichannel audio objects to mix and information of a mix rate of the multichannel audio objects.

The channel down-mixers 120-1 through 120-P down-mix the input multichannel audio objects. The channel down-mixing is the audio processing for reducing the channel of the audio channel from the multiple channels to a lower number of channels.

For example, the channel down-mixing can be the audio processing which reduces the audio object channel from 5.1 channel to stereo (two) channels. In this case,

1) the L-channel and the R-channel of the audio object can be mixed into one channel and a spatial parameter can be generated,

2) the RL-channel and the RR-channel of the audio object can be mixed into one channel and a spatial parameter can be generated,

3) the C-channel and the SW-channel of the audio object can be mixed into one channel and a spatial parameter can be generated, and

4) the mixed channel of 1) and the mixed channel of 2) can be mixed into one channel and a spatial parameter can be generated.

As the result of the channel down-mixing, the channel mixed in 3), the channel mixed in 4), and the four spatial parameters are generated.

For example, the channel down-mixing can be the audio processing which reduces the channel of the audio object from 5.1 channel to mono channel (one channel). In this case,

1) the L-channel and the R-channel of the audio object can be mixed into one channel and a spatial parameter can be generated,

2) the RL-channel and the RR-channel of the audio object can be mixed into one channel and a spatial parameter can be generated,

3) the C-channel and the SW-channel of the audio object can be mixed into one channel and a spatial parameter can be generated,

4) the mixed channel of 1) and the mixed channel of 2) can be mixed into one channel and a spatial parameter can be generated, and 5) the mixed channel of 4) and the mixed channel of 3) can be mixed into one channel and a spatial parameter can be generated.

Hence, as the result of the channel down-mixing, the channel mixed in 5) and the five spatial parameters are generated.

The audio encoders 130-1 through 130-P encode and compress the audio objects down-mixed by the channel down-mixers 120-1 through 120-P.

As a result, 1) the first audio encoder 130-1 outputs the first audio object down-mixed and encoded, 2) the second audio encoder 130-2 outputs the second audio object down-mixed and encoded, . . . , and P) the P-th audio encoder 130-P outputs the P-th audio object down-mixed and encoded.

The encoded audio objects include the spatial parameters in addition to the compressed audio data.

The audio MUX 140 generates one multichannel multitrack audio by multiplexing the audio objects encoded by the audio encoders 130-1 through 130-P and additional information.

The additional information contains mix information and play control information. The mix information is explained earlier. The play control information is information relating to the mix rate of the multichannel audio objects when the multichannel multitrack audio is played, and is written by an audio expert.

2. Multichannel Multitrack Audio Generating Method

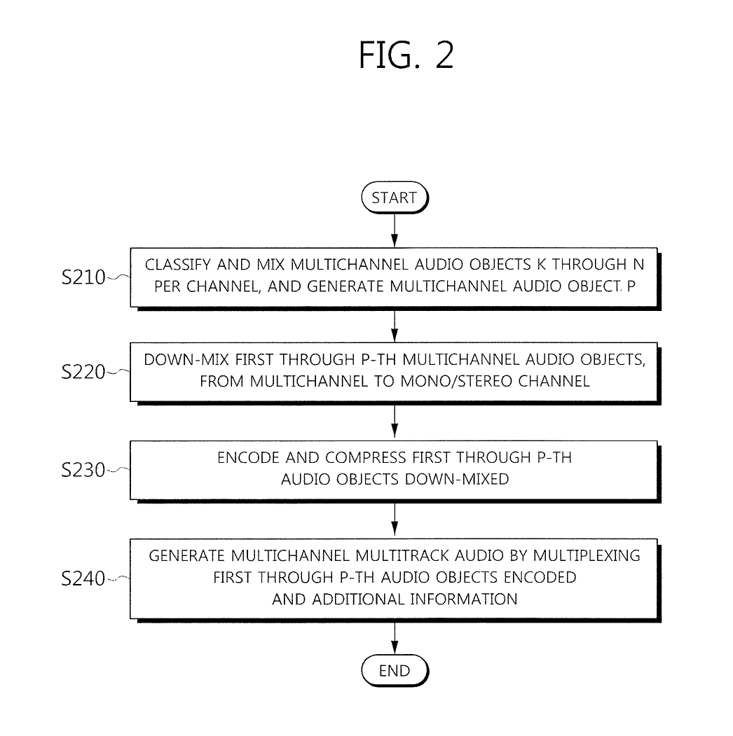

Hereafter, a method for generating the multichannel multitrack audio of the multichannel multitrack audio generating apparatus of FIG. 1 is explained in detail by referring to FIG. 2. FIG. 2 is a flowchart of a method for generating the multichannel multitrack audio according to an exemplary embodiment of the present invention.

As shown in FIG. 2, the multichannel audio mixer 110 of the multichannel multitrack audio generating apparatus 100 classifies and mixes the multichannel audio objects K through N per channel, and generates the multichannel audio object P (S210).

The channel down-mixers 120-1 through 120-P down-mix the multichannel of the first through P-th multichannel audio objects, to the mono or stereo channel (S220).

Next, the audio encoders 130-1 through 130-P encode and compress the first through P-th audio objects down-mixed in S220 (S230).

The audio MUX 140 generates the single multichannel multitrack audio by multiplexing the first through P-th audio objects encoded in S230 and the additional information (S240).

3. Multichannel Multitrack Audio Reproducing Apparatus

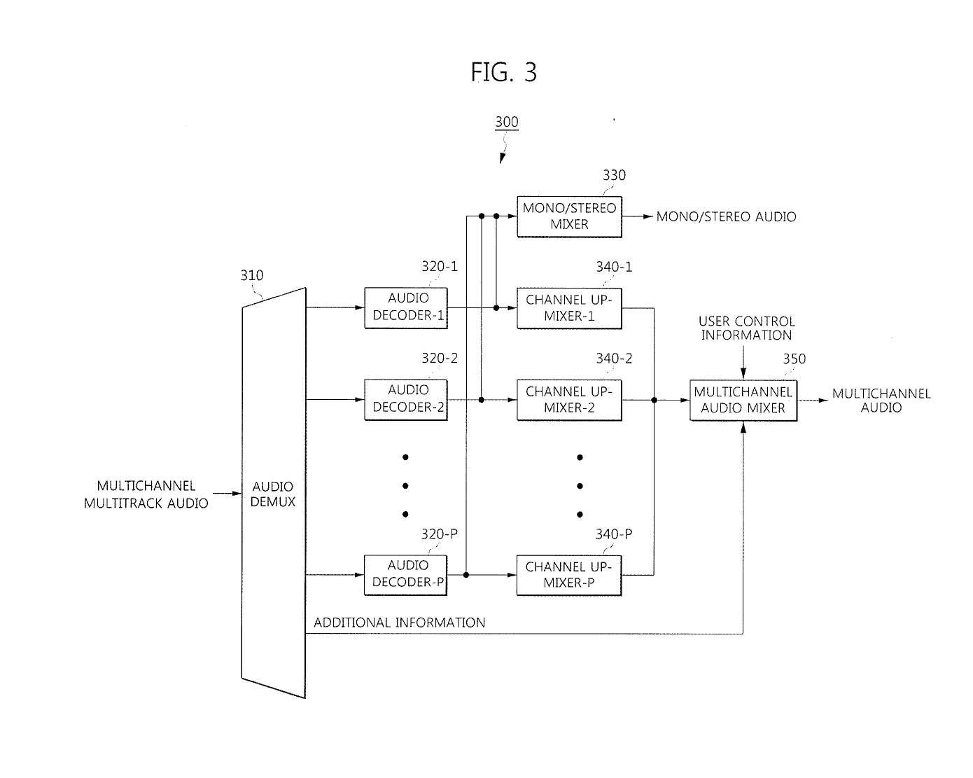

FIG. 3 is a block diagram of a multichannel multitrack audio reproducing apparatus according to an exemplary embodiment of the present invention. The multichannel multitrack audio reproducing apparatus 300 up-mixes the audio objects constituting the multichannel multitrack audio generated by the multichannel multitrack audio generating apparatus 100 of FIG. 1, to the multichannel, mixes the audio objects, and thus outputs the single multichannel audio.

Such a multichannel multitrack audio reproducing apparatus 300 includes an audio DEMUX 310, audio decoders 320-1 through 320-P, a mono/stereo mixer 330, channel up-mixers 340-1 through 340-P, and a multichannel audio mixer 350 as shown in FIG. 3.

The audio DEMUX 310 demultiplexes and outputs the encoded audio objects and the additional information in the multichannel multitrack audio generated by the multichannel multitrack audio generating apparatus 100. The additional information contains the mix information and the play control information as mentioned earlier.

The audio decoders 320-1 through 320-P decode and decompress the encoded audio objects demultiplexed by the audio DEMUX 310. In result, the audio decoders 320-1 through 320-P output the audio objects down-mixed by the channel down-mixers 120-1 through 120-P of FIG. 1.

The channel of the down-mixed audio objects output from the audio decoders 320-1 through 320-P is in mono or stereo, which can be determined according to which one of the down-mixers 120-1 through 120-P of FIG. 1 down-mixes the audio object.

The mono/stereo mixer 330 outputs the single audio by mixing the audio objects output from the audio decoders 320-1 through 320-P. When the audio decoders 320-1 through 320-P output the stereo audio objects, the mono/stereo mixer 330 classify and mix the audio objects per channel.

The channel up-mixers 340-1 through 340-P up-mix the decoded audio objects output from the audio decoders 320-1 through 320-P.

The channel up-mix is the reverse processing of the channel down-mix, and increases the channel of the audio object from the lower number of channels to the multichannel. As examples of the channel up-mix, 1) the channel of the audio object can be increased from the stereo channel (2 channels) to 5.1 channel, and 2) the channel of the audio object can be increased from the mono channel (1 channel) to 5.1 channel. The channel up-mixing refers to the spatial parameters generated in the channel down-mixing.

The multichannel audio mixer 350 classifies and mixes the multichannel audio objects up-mixed by the channel up-mixers 340-1 through 340-P per channel. Hence, the channel audio mixer 350 generates and outputs the single multichannel audio.

The mix rate of the multichannel audio objects of the multichannel audio mixer 350 is determined by user control information or the play control information contained in the additional information.

As shown in FIG. 3, the multichannel multitrack audio input to the audio DEMUX 310 can be 1) output as the mono/stereo audio from the mono/stereo mixer 330 or 2) output as the multichannel audio from the multichannel audio mixer 350. The output path can be selected by the user.

4. Multichannel Multitrack Audio Reproducing Apparatus

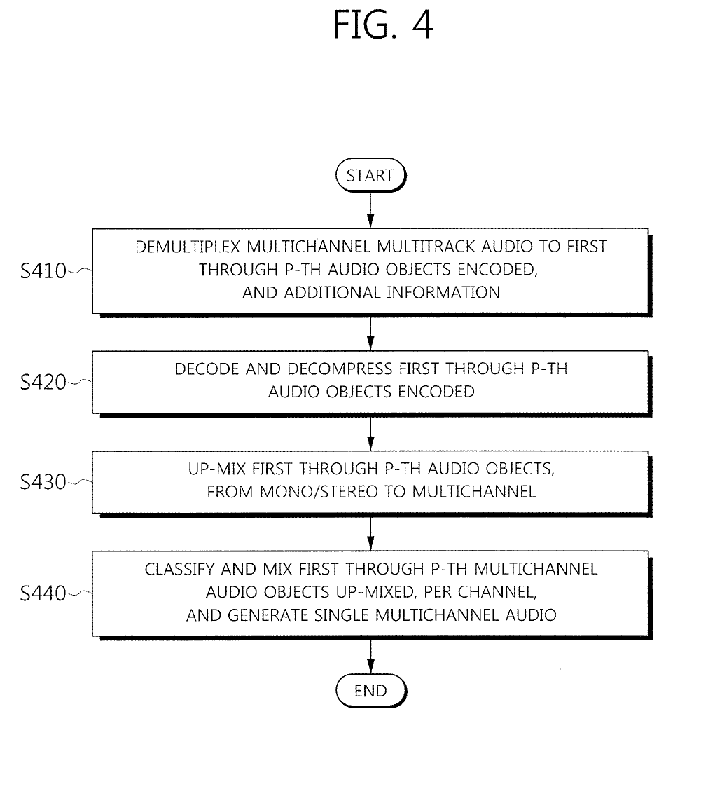

Hereafter, a method for reproducing the multichannel multitrack audio of the multichannel multitrack audio reproducing apparatus of FIG. 3 is explained in detail by referring to FIG. 4. FIG. 4 is a flowchart of a method for reproducing the multichannel multitrack audio according to an exemplary embodiment of the present invention.

As shown in FIG. 4, the audio DEMUX 310 of the multichannel multitrack audio reproducing apparatus 300 demultiplexes the input multichannel multitrack audio to the first through P-th audio objects encoded and the additional information (S410).

The audio decoders 320-1 through 320-P separate the spatial parameters and decompresses the audio objects by decoding the encoded first through P-th audio objects demultiplexed in S410 (S420).

The channel up-mixers 340-1 through 340-P up-mix the first through P-th audio objects decoded in S420 by referring to the spatial parameters separated in S420 (S430). In S430, the mono or stereo audio objects are converted to the multichannel audio objects.

The multichannel audio mixer 350 classifies and mixes the first through P-th multichannel audio objects up-mixed in S430, per channel (S440). Thus, the single multichannel audio is generated and output in S440.

5. Modifications

In FIG. 1, the (K−1)-ary multichannel audio objects are separately down-mixed, and the (N-K−1)-ary multichannel audio objects are mixed into the single multichannel audio object, and then down-mixed. In FIG. 3, its reverse processing is performed to ease the understanding. (K−1) and (N-K−1) can be altered.

The single audio object group is mixed to the single multichannel audio object before the channel down-mixing to ease the understanding. Accordingly, two or more audio object groups can be mixed to the single multichannel audio object before the channel down-mixing.

For example, 1) the K-th multichannel audio object, the (K+1)-th multichannel audio object, and the (K+2)-th multichannel audio object can be mixed to the single multichannel audio object and then down-mixed, and 2) the (K+3)-th through N-th multichannel audio objects can be mixed to the single multichannel audio object and then down-mixed.

In this case, the number of the multichannel audio mixers 110 should be increased.

Above numbers can be fixed but varied according to the characteristics of the multichannel multitrack audio to generate/reproduce.

It is possible to implement the multichannel multitrack audio generating apparatus and reproducing apparatus as the single audio system. At this time, the audio system is applicable to devices having the primary audio generating/reproducing function such as MP3 player, HTS, and TV, and devices having the secondary audio generating/reproducing function such as mobile phone and mobile PC.

The multichannel multitrack audio generating method and reproducing method can be realized as the single audio processing method.

Since the aforementioned 5.1 channel is an example of the multichannel and the mono/stereo are examples of the lower number of channels, the number of the multichannel and the lower number of channels can vary.

While the audio objects constituting the multichannel multitrack audio can be classified per instrument as above, English conversation audio can be classified per dialogist.

As set forth above, the method for down-mixing the audio objects of the audio from the multichannel to the lower number of channels generates the multichannel multi-object audio and reproduces the generated multichannel multi-object audio. Thus, the abrupt data increase can be addressed in processing the multichannel multi-object audio.

In addition, the method for classifying and mixing part of the audio objects of the audio per channel and then down-mixing from the multichannel to the lower number of channels can generate the multichannel multi-object audio and reproduce the generated multichannel multi-object audio. Hence, only the data size of the minor audio objects of the audio can be reduced and thus the sound quality degradation of the major audio objects of the audio can be prevented.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An audio processing method comprising:
down-mixing a first audio object constituting audio from multichannel to a lower number of channels; and
encoding the first audio object down-mixed.

2. The audio processing method of claim 1, further comprising:
down-mixing a second audio object constituting the audio from multichannel to a lower number of channels;
encoding the second audio object down-mixed; and
generating single multichannel multitrack audio by multiplexing the first audio object down-mixed and encoded and the second audio object down-mixed and encoded.

3. The audio processing method of claim 1, further comprising:
generating a third audio object by classifying and mixing part of the audio objects of the audio per channel;
down-mixing the third audio objects from multichannel to a lower number of channels;
encoding the third audio objects down-mixed; and
generating single multichannel multitrack audio by multiplexing the first audio object down-mixed and encoded and the third audio object down-mixed and encoded.

4. The audio processing method of claim 1, wherein the lower number of the channels is one or two.

5. An audio processing method comprising:
decoding a first audio object constituting audio, the audio object down-mixed and then encoded; and
up-mixing the decoded first audio object down-mixed, from a lower number of channels to multichannel.

6. The audio processing method of claim 5, further comprising:
decoding the second audio object constituting the audio, the audio object down-mixed and encoded;
up-mixing the decoded second audio object down-mixed, from a lower number of channels to multichannel; and
generating single multichannel audio by mixing the first audio object up-mixed and the second audio object up-mixed.

7. The audio processing method of claim 5, further comprising:
classifying and mixing part of audio objects constituting the audio per channel, and decoding a third audio object down-mixed from multichannel to a lower number of channels;
up-mixing the decoded third audio object down-mixed, from a lower number of channels to multichannel; and
generating single multichannel audio by mixing the first audio object up-mixed and the third audio object up-mixed.

8. The audio processing method of claim 5, further comprising:
classifying and mixing part of audio objects constituting the audio per channel, and decoding a third audio object down-mixed from multichannel to a lower number of channels; and
generating single audio of a lower number of channels by mixing the first audio object decoded and up-mixed and the third audio object decoded and up-mixed.
